(19) United States
(12) Patent Application Publication
(10) Pub. No.: US 2015/0087256 A1
(43) Pub. Date: Mar. 26, 2015

(54) Emergency Responder System For Portable Communication Device

(71) Applicant: Annalee E. Carter, Wilmington, NC (US)

(72) Inventor: Annalee E. Carter, Wilmington, NC (US)

(21) Appl. No.: 14/038,741

(22) Filed: Sep. 26, 2013

(51) Int. Cl. H04W 4/22

(52) U.S. Cl. CPC H04W 4/22
USPC 455/404.1

(57) ABSTRACT

An emergency communications system may transmit vital emergency data to a portable communications device of a first responder based on an identifier associated with a victim. In one example, the identifier is read by a first portable communications device (e.g., of a first responder) from a second portable communications device (e.g., of an accident victim). In another example, the portable communications device of an injured person may be transmit the identifier to a remote device to initiate the download of previously stored emergency data. The emergency data may be matched to the identifier at the remote device. A touch sequence on a display of the portable communications device may override passcode protections to automatically initiate an emergency response operation. For instance, video data may be automatically recorded and uploaded by portable communications device.

### CLAIM OF PRIORITY

This application is a continuation patent application of, and claims priority from, U.S. Provisional Patent Application Ser. No. 61/705667, filed on Sep. 26, 2012 and entitled, “Smartphone Emergency Application,” by Annalee E. Carter and which is incorporated by reference herein in its entirety for all purposes.

### FIELD OF THE DISCLOSURE

The present disclosure relates generally to portable electronic communication systems, and more specifically, to portable communication devices used by first responders in a medical emergency.

### BACKGROUND

First responders at an accident scene must quickly assess the health and safety conditions concerning a victim. The speed and accuracy at which they can grasp and relate this vital information speeds appropriate lifesaving responses and directly translates into saved lives.

### SUMMARY OF THE DISCLOSURE

In a particular embodiment, an apparatus may include a processor and program code executable by the processor to read an identifier associated with emergency data corresponding to an individual. The processor may further transmit the identifier to a remote device. The identifier may be matched to the emergency data. The program code may be further executed to receive the emergency data transmitted from the remote device. According to one example, the emergency data may be communicated to an emergency responder via the apparatus. The identifier is generated at and read from a portable communications device.

The emergency data may be communicated to the portable communications device. According to an embodiment, the emergency data is communicated to the apparatus via the portable communications device. The program code may be executed to notify an emergency responder of the presence of the identifier. Examples of emergency data may include a blood type, an allergy listing, a name of a victim, medical condition information, living will information, a religious instruction, prescription information, and contact information, among others.

The program code may be executed to prompt a user to input the emergency data. Alternatively or additionally, the emergency data may be retrieved from a server database that is remote from the remote device. The identifier may include one or more of a printed image, an electronic image, or a transmitted signal. The program code may further be executed to override a passcode in response to the touch pattern. The apparatus may include a display, and at least one of the emergency data and the identifier may be displayed in response to touching the display to make a touch pattern. An amount (and type) of the emergency data transmitted from the remote device may be determined according to a determined level of security associated with the apparatus.

According to another embodiment, an apparatus includes a processor and program code executable by the processor to receive an overriding input configured to override a security code associated with limiting access to the apparatus. In response to the overriding input, an identifier may be transmitted to a remote device. The identifier may be associated with emergency data corresponding to an individual. The identifier may be matched to the emergency data. The overriding input may include at least one of a user creating a touch patter across a display and a voice input. The program code may be executed to initiate a training session for a user to practice the touch pattern.

According to another particular embodiment, an apparatus includes a recording module, a processor, and program code executable by the processor to receive an input configured to automatically establish a video communication link with an emergency responder server. The processor may further initiate a video upload of data recorded by the recording module. A downlink of the recorded data may be transmitted from the emergency responder server to a portable communications device. The input may be received from at least one of the emergency responder server and a user at the apparatus.

Embodiments of an emergency communications system for portable communications devices may facilitate timely care injured persons by instantly providing vital emergency data to first responders. Emergency communications may utilize portable communications devices carried on the persons of the victim and/or the first responder. The emergency communications may be automated and include real time video to further streamline lifesaving information.

Features that characterize embodiments are set forth in the claims annexed hereto and forming a further part hereof. However, for a better understanding of embodiments, and of the advantages and objectives attained through their use, reference should be made to the drawings and to the accompanying descriptive matter,

### BRIEF DESCRIPTION OF THE DRAWINGS

FIG. 1 shows an embodiment of a communications system configured to transmit vital emergency data to a portable communications device of a first responder based on an identifier associated with a victim; and

FIG. 2 shows an embodiment of a communications system configured to transmit vital emergency data to a portable communications device based on an identifier associated with a portable communications device.

### DETAILED DESCRIPTION

An embodiment of an emergency communications system transmits vital emergency data to a portable communications device of a first responder based on an identifier associated with a victim. In one example, the identifier is read by a first portable communications device (e.g., of a first responder) from a second portable communications device (e.g., of an accident victim). In another example, the portable communications device of an injured person may be transmit the identifier to a remote device to initiate the download of previously stored emergency data. The emergency data may be matched to the identifier at the remote device. A touch sequence on a display of the portable communications device may override passcode protections to automatically initiate an emergency response operation. For instance, video data may be automatically recorded and uploaded by portable communications device.

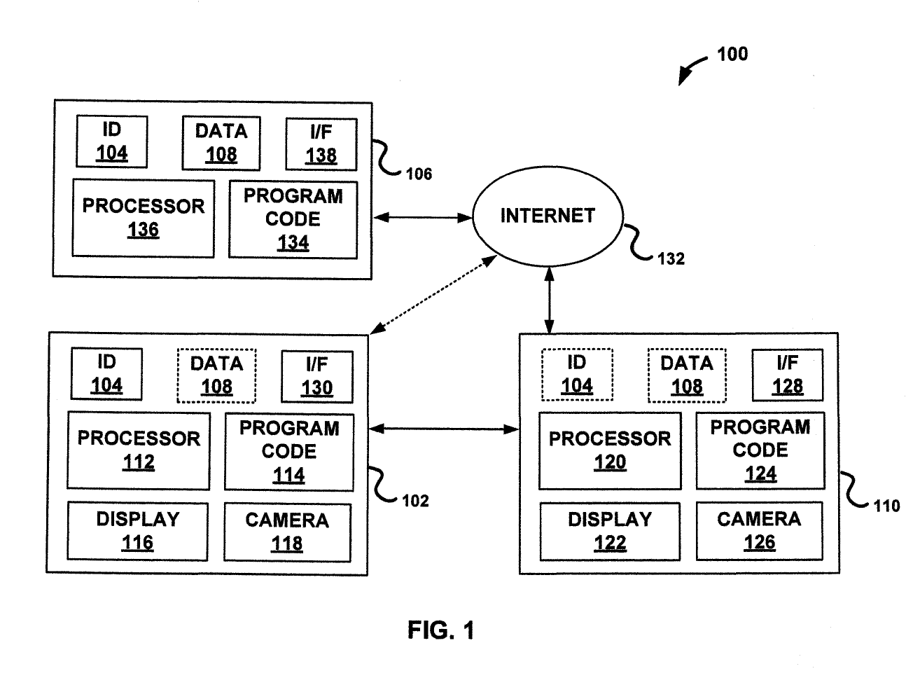

Turning more particularly to the Drawings, FIG. 1 shows an embodiment of a communications system 100 configured to transmit vital emergency data to a portable communications device of a first responder based on an identifier associated with a victim. The portable communications device 102 may be used to determine an identifier 104 associated with an accident victim. The identifier 104 may be matched at a remote device 106 to determine emergency data 108 associated with the accident victim.

In a particular embodiment, the identifier 104 may include a printed image, such as a sticker having a bar code or a sequence of numbers. While shown in FIG. 1 as being included in a portable communications device 110, could also be a printed image on a driver's license, automobile bumper, bracelet, or key chain, for instance. As such, printed images may be mailed to persons, where the images can be scanned to immediately retrieve the emergency data 108.

The identifier 104 may additionally or alternatively include an electronic image (e.g., of number sequence, a bar code, or other symbol). For instance, the portable communications device 110 of the accident victim may include or be used to produce an electronic image. The identifier may also include information transmitted in an electronic signal communicated between the portable communication devices 102, 110. Such a signal may comprise a wireless, non-contact signal, such as a radio-frequency identification (RFID) signal, for instance.

The portable communications device 102 may include a processor 112 configured to execute program code 114. As discussed herein, the processor 112 may be execute the program code 114 to read the identifier 104 associated with the emergency data 108 corresponding to the accident victim. For example, a cellular telephone carried by a police officer may have an application configured to read the identifier 104. Thus, a police department would not require additional hardware to read identifiers. The program code 114 may be further executed to transmit the identifier 104 to the remote device 106, wherein the identifier 104 is matched to the emergency data 108. The portable communications device 102 may receive the emergency data 108 from the remote device 106. The portable communications device 102 may additionally include a display 116 and a camera 118.

Similarly, the portable communications device 110 may include a processor 120, a display 122, program code 124, and a camera 126. The portable communications device 110 may also include a wireless interface 128, similar to a wireless interface 130 of the portable communications device 102. In a particular embodiment, the processor 120 may execute the program code 124 to generate and/or produce the identifier 104 for the portable communications device 102. For example, the portable communications device 110 may automatically initiate the wireless transfer of the identifier 104 to the portable communications device 102 when the devices are within a preset proximity of one another. For instance, a transponder of either device 102, 110 may send out a signal seeking the other, or may initiate communications with the remote device 106. In one example, a user may initiate the seeking transponder signal. In another instance, the transponder signal may be initiated by another automated process, such as an alarm initiated by an onboard vehicular alert system that activates in response to a suspected crash. Alternatively or additionally, the portable communications device 110 may initiate an audible alarm and/or visual flashing when the devices 102, 110 are proximate one another.

The remote device 106 may comprise a server having databases or other memory storing emergency data 108 for multiple persons. The remote device 106 may include program code 134 executable by a processor 136. The emergency data 108 may be stored in association with multiple identifiers that uniquely identify the persons. In the embodiment of FIG. 1, the remote device 106 communicates with the portable communication device 102 via an Internet connection 132 using an interface 138. The remote device of another embodiment may be relatively more locally situated and may communicate without use of the Internet and may, instead, use a local connection.

The emergency data 108 may include information most helpful to a first responder, as opposed to a complete listing of medical and non-medical data that may not be vital in the critical first seconds that a first responder arrives at an accident scene. Examples of such emergency data 108 may include: a blood type, an allergy listing, a name of a victim, medical condition information (e.g., asthma, diabetes, heart condition information), living will information, a religious instruction, prescription information, and contact information of a victim and their loved ones. The emergency data 108 may be downloaded and presented in such a manner as the information is likely to be needed and requested by a first responder or emergency dispatch. A user may be prompted at a portable communications device 110 (e.g., when activating an emergency communication service) to enter the emergency data 108. The emergency data 108 may then be uploaded and stored at a memory accessible to the remote device 106. Alternatively or additionally, the emergency data 108 may be farmed or parsed out from existing data stored in a database that includes previously entered information. In such a scenario, program code may identify and retrieve only the relevant emergency data 108.

The amount and type of emergency data 108 downloaded from the remote device 106 may be determined according to a security parameter assigned to the portable communication device 102 and/or the portable communication device 110. For example, a security certificate of the portable communication device 102 may be authenticated at the remote device 106 before the emergency data 108 is downloaded. The amount of the emergency data 108 may additionally be limited according to the security parameter assigned to the user of the portable communication device 102. For instance, an emergency responder having a portable communication device in communication with a remote device may be authorized to receive a larger amount of emergency data then might a non-authorized, non-professional responder on arriving at the accident scene.

The system 100 may enable video (including accompanying audio data) to be uploaded to from one of the portable communication devices 102, 110 to the remote device 106. For example, video data of an accident or criminal scene may be sent to the remote device 106 for use by a dispatcher to better assess an accident. The uploaded video may automatically initiate a video chat with a dispatcher, and/or may be logged and placed in a queue. For example, the video data may be accessible in an activity log on a display of a dispatcher that shows date/time data, in addition to global positioning satellite (GPS) data. The video upload may be initiated locally at a portable communications device 102, 110, or may be initiated remotely by the remote device 106, for instance. The uploaded video data may be stored for transmittal and evidentiary considerations. The video data may further be downloaded from the remote device 106 to a portable communications device of an approaching emergency responder. Such video data may have particular application in a scenario where a suspect is being filmed, or where a phone user is uncertain of their location and pans the locality to help the emergency responders determine their location. Such a scenario may assist in the recovery of a lost child, as well. While video may be preferred, another embodiment may use still data images.

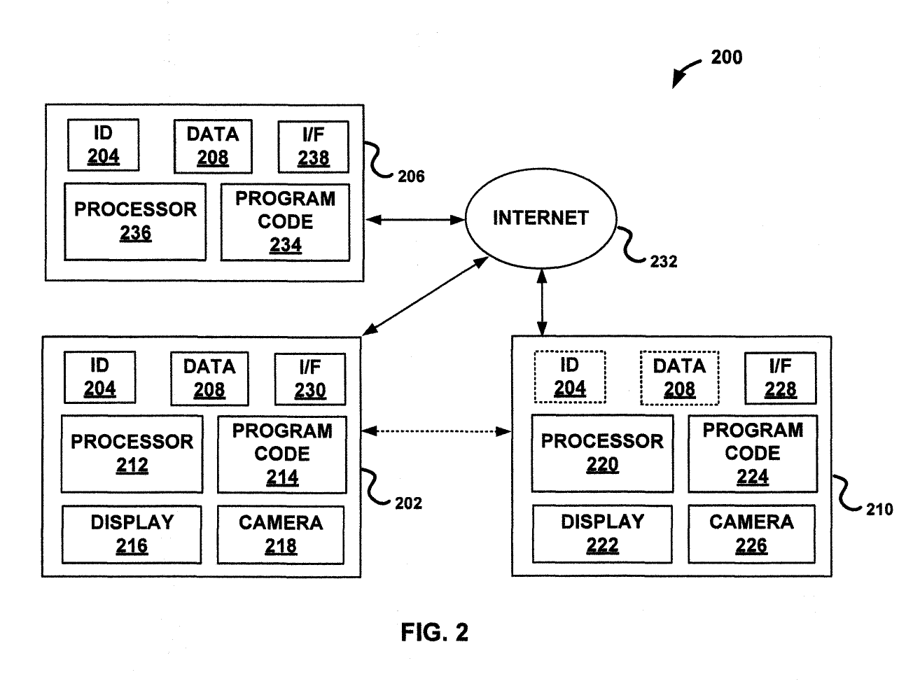

FIG. 2 shows an embodiment of a communications system configured to transmit vital emergency data to a portable communications device of a first responder based on an identifier associated with an accident victim. Turning more particularly to the Drawings, the communications system 200 may be similar to that shown in FIG. 1, except the portable communications device 110 of an accident victim may be used to communicate directly with a remote device 206. For example, an identifier 204 of the portable communications device 210 may be communicated to the remote device 206, where is may be matched to determine emergency data 208 associated with the accident victim. The identifier 204 may be transmitted concurrently to both the remote device 206 and to the portable communication device 202.

In a particular embodiment, a user may touch a display 222 of the portable communications device 210 to override a passcode that otherwise prevents access to the portable communications device 210. For instance, a touch pattern comprising a finger drag and/or sequence of finger touches on the display 222 may initiate emergency communications with at least one of the remote device 206 and a second portable communications device 202. This feature may allow a user familiar with the portable communications device 210 to quickly and easily call for emergency assistance without having to negotiate inputting a passcode or initiating additional applications.

Additionally, a person unfamiliar with the portable communications device 210, such as a child or a good Samaritan attempting to assist an injured individual, may use the overriding touch pattern to initiate emergency communications without knowing the passcode and without accessing other features of the portable communications device 210. Once the emergency response is underway, the normal security operations of the portable communications device 210 may resume, thus preventing further access to the portable communications device 210. To this end, the touch pattern may be universally known, or at least known by those who might conceivably have contact with the portable communications device 210. For example, a user may trace “911” across the display 210. Program code may include a game or exercise meant to practice and reinforce the touch pattern in the mind of a child or elder, for instance.

The portable communications device 210 may include a processor 220, a display 222, program code 224, and a camera 226. The portable communications device 210 may also include a wireless interface 228. In a particular embodiment, the processor 220 may execute the program code 224 to generate and/or transmit the identifier 204 to the remote device 206. In one example, a transponder of either device 202, 210 may send out a signal seeking the other, or may initiate communications with the remote device 206. A user may initiate the seeking transponder signal. In another instance, the transponder signal may be initiated by another automated process, such as an alarm initiated by an onboard vehicular alert system that activates in response to a suspected crash. The portable communications device 210 may initiate an audible alarm and/or visual flashing when the devices 202, 210 are proximate one another. Alternatively or additionally, the portable communications device 210 may initiate an audible alarm and/or visual flashing when the devices 202, 210 are proximate one another.

The remote device 206 may comprise a server having databases storing emergency data 208 for multiple persons. The emergency data 208 may be stored in association with multiple identifiers that uniquely identify the persons. In the embodiment of FIG. 2, the remote device 206 communicates with the portable communication device 210 via an Internet connection 232. The remote device of another embodiment may be relatively more locally situated and may communicate without use of the Internet.

The portable communications device 202 may include a processor 212 configured to execute program code 214. The portable communications device 202 may additionally include a display 216 and a camera 218.

The system 200 may enable video (including accompanying audio data) to be uploaded to from one of the portable communication devices 202, 210 to the remote device 206. For example, video data of an accident or criminal scene may be sent to the remote device 206 for use by a dispatcher to better assess an accident. The uploaded video may automatically initiate a video chat with a dispatcher, and/or may be logged and placed in a queue. For example, the video data may be accessible in an activity log on a display of a dispatcher that shows date/time data, in addition to global positioning satellite (GPS) data. The video upload may be initiated locally at a portable communications device 102, 110, or may be initiated remotely by the remote device 206, for instance. As discussed above, the uploaded video data may be stored for transmittal and evidentiary considerations. The video data may further be downloaded from the remote device 106 to the portable communications device 202 of an approaching emergency responder. While video may be preferred, another embodiment may use still data images.

The emergency data 208 may include information tailored to a first responder, as opposed to a complete listing of medical and non-medical data that may not be vital in the critical first seconds that a first responder arrives at an accident scene. Examples of such emergency data 208 may include: a blood type, an allergy listing, a name of a victim, medical condition information, living will information, a religious instruction, prescription information, and contact information of a victim and their loved ones. A user may be prompted at a portable communications device 210 (e.g., when activating an emergency communication service) to enter the emergency data 208. The emergency data 208 may then be uploaded and stored at a memory accessible to the remote device 206. Alternatively or additionally, the emergency data 208 may be farmed or parsed out from existing data stored in a database that includes previously entered information. In such a scenario, program code may identify and retrieve only the relevant emergency data 208.

The amount and type of emergency data 208 downloaded from the remote device 206 may be determined according to a security parameter assigned to the portable communication device 210. For example, a security certificate of the portable communication device 210 may be authenticated at the remote device 106 before the emergency data 208 is downloaded. The amount of the emergency data 208 may additionally be limited according to the security parameter assigned to the user of the portable communication device 210. In another example, an emergency responder having a portable communication device 202 in communication with a remote device 206 may be authorized to receive a larger amount of emergency data then might a non-authorized, non-professional responder on arriving at the accident scene.

While the present embodiments have been described in detail, it is not the intention of the Applicant to restrict, or any way limit the scope of the appended claims to such detail. The embodiments in their broader aspects are therefore not limited to the specific details, representative apparatus, methods, and illustrative examples shown and described. Accordingly, departures may be made from such details without departing from the scope of Applicant's general inventive concept.

1. An apparatus comprising:
a processor;
program code executable by the processor to:
read an identifier associated with emergency data corresponding to an individual;
transmit the identifier to a remote device, wherein the identifier is matched to the emergency data.

2. The apparatus of claim 1, further comprising executing the program code to receive the emergency data transmitted from the remote device.

3. The apparatus of claim 1, wherein the emergency data is communicated to an emergency responder via the apparatus.

4. The apparatus of claim 1, wherein the identifier is generated at and read from a portable communications device.

5. The apparatus of claim 4, wherein the emergency data is communicated to the portable communications device.

6. The apparatus of claim 5, wherein the emergency data is communicated to the apparatus via the portable communications device.

7. The apparatus of claim 1, further comprising executing the program code to notify an emergency responder of the presence of the identifier.

8. The apparatus of claim 1, further comprising executing the program code to prompt a user to input the emergency data.

9. The apparatus of claim 1, wherein the emergency data is retrieved from a server database that is remote from the remote device.

10. The apparatus of claim 1, wherein the identifier is at least one of a printed image, an electronic image, and a transmitted signal.

11. The apparatus of claim 1, wherein the emergency data includes a blood type, an allergy listing, a name of a victim, medical condition information, living will information, a religious instruction, prescription information, and contact information.

12. The apparatus of claim 1, further comprising a display, wherein at least one of the emergency data and the identifier is displayed in response to touching the display to make a touch pattern.

13. The apparatus of claim 12, further comprising executing the program code to override a passcode in response to the touch pattern.

14. The apparatus of claim 1, further comprising receiving an amount of the emergency data transmitted from the remote device according to a determined level of security associated with the apparatus.

15. An apparatus comprising:
a processor;
program code executable by the processor to:
receive an overriding input configured to override a security code associated with limiting access to the apparatus;
in response to the overriding input, transmitting to a remote device an identifier associated with emergency data corresponding to an individual, wherein the identifier is matched to the emergency data.

16. The apparatus of claim 15, wherein the overriding input includes at least one of a user creating a touch patter across a display and a voice input.

17. The apparatus of claim 15, further comprising executing the program code to initiate a training session for a user to practice the touch pattern.

18. An apparatus comprising:
a recording module;
a processor;
program code executable by the processor to:
receive an input configured to automatically establish a video communication link with an emergency responder server; and
initiate a video upload of data recorded by the recording module.

19. The apparatus of claim 18, wherein a downlink of the recorded data is transmitted from the emergency responder server to a portable communications device.

20. The apparatus of claim 18, wherein the input is received from at least one of the emergency responder server and a user at the apparatus.
